(19) United States
(12) Patent Application Publication
(10) Pub. No.: US 2004/0043861 A1
(43) Pub. Date: Mar. 4, 2004

(54) Method and an apparatus for transferring torque and a hybrid vehicle incorporating the method and apparatus

(75) Inventors: Joseph Gerald Supina, Belleville, MI (US); Shailesh S. Kozarekar, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI

(21) Appl. No.: 10/463,046

(22) Filed: Jun. 17, 2003

Related U.S. Application Data
(63) Continuation of application No. 09/848,038, filed on May 3, 2001, now abandoned.

(51) Int. Cl. B60K 1/02

(52) U.S. Cl. 477/3

(57) ABSTRACT

A method and an apparatus 10 for transferring torque from at least one torque generator 12, 14 to at least one wheel 20 of a hybrid vehicle. The apparatus 10 includes a operatively coupled pair of clutches 24, 26 which cooperatively provide a dynamically adjustable gear ratio, effective to allow the vehicle to be quickly and efficiently launched and efficiently operated after launch.

### FIELD OF THE INVENTION

The present invention generally relates to a method and an apparatus for transferring torque and to a hybrid vehicle incorporating the method and apparatus and more particularly, to an assembly for use within a hybrid vehicle which provides several gear ratios and which dynamically modifies the provided gear ratio in response to a sensed operational mode of the hybrid vehicle, effective to allow the hybrid vehicle to be efficiently operated and to be quickly and efficiently launched.

### BACKGROUND OF THE INVENTION

A hybrid electric vehicle typically includes an internal combustion engine and an electric motor which cooperatively or independently generate torque which is communicated to the wheels of the vehicle, effective to allow the hybrid vehicle to be selectively driven and maneuvered.

At launch (e.g., during a desired acceleration of the vehicle), it is desirable to communicate a relatively large amount of torque emanating from the electric motor and/or from the internal combustion engine to the wheels (e.g., though a torque multiplier assembly) in order to allow the launch to quickly occur. However, once the launch has occurred, it is desirable to reduce the amount of torque which is communicated to the wheels in order to conserve fuel and/or to increase the amount of vehicular speed.

Conventionally, in a hybrid vehicle, the gear assembly, which couples the internal combustion engine and/or the electric motor (e.g., each of the torque generators or sources) to the wheels, provides a fixed gear ratio which allows a fixed amount of the generated torque to be communicated to the wheels and hence does not allow the amount of transferred torque to be desirably varied in the manner set forth above.

While some attempts have been made to provide different gear ratios in a hybrid electric vehicle, these attempts require the use of multiple types of gears (e.g., a planetary gear and several spur gears), thereby increasing the overall complexity and cost of the vehicle. Further, these arrangements also fail to provide a “neutral” gear arrangement which desirably reduces the likelihood of engine or component damage as the vehicle is towed, and these arrangements do not easily allow the electrical power source to be regenerated.

There is therefore a need for an assembly which dynamically adjusts the amount of torque which is transferred or communicated to the wheels of a hybrid type vehicle by selectively providing one of several gear ratios, effective to allow vehicular launch to quickly and efficiently occur and to allow an electric motor and internal combustion engine to efficiently operate, and which provides these operational benefits in a manner which overcomes some or all previously delineated drawbacks of prior assemblies/techniques.

### SUMMARY OF THE INVENTION

It is a first non-limiting advantage of the present invention to provide a method and an apparatus for transferring torque in a manner which overcomes some or all of the previously delineated drawbacks of prior methods and apparatuses.

It is a second non-limiting advantage of the present invention to provide a hybrid vehicle which utilizes the method and apparatus of the preferred embodiment of the invention.

According to a first non-limiting aspect of the present invention, an assembly which regulates the amount of torque which is communicated to at least one wheel of a hybrid vehicle is provided.

According to a second non-limiting aspect of the present invention, a hybrid vehicle is provided and includes at least two torque production sources; at least one wheel; and a transmission assembly which is adapted to selectively receive a first amount of torque from at least one of the at least two sources and to communicate a second and third amounts of torque to the at least one wheel; and a controller which is coupled to the transmission assembly and which causes the second amount of torque to be communicated to the at least one wheel during launch and the third amount of torque to be communicated to the at least one wheel after launch, wherein the third amount of torque is less than the second amount of torque.

According to a third aspect of the present invention, a method for transmitting torque emanating from at least one of two torque production sources to at least one wheel is provided. The method comprises the steps of providing an assembly having a selectable gear ratio; transmitting the torque to the assembly; and communicating at least a portion of the torque from the assembly to the at least one wheel.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is block diagram of a torque transfer assembly which is made in accordance with the teachings of the preferred embodiment of the invention.

### DETAILED DESCRIPTION OF THE PREFERRED EMBODIMENT OF THE INVENTION

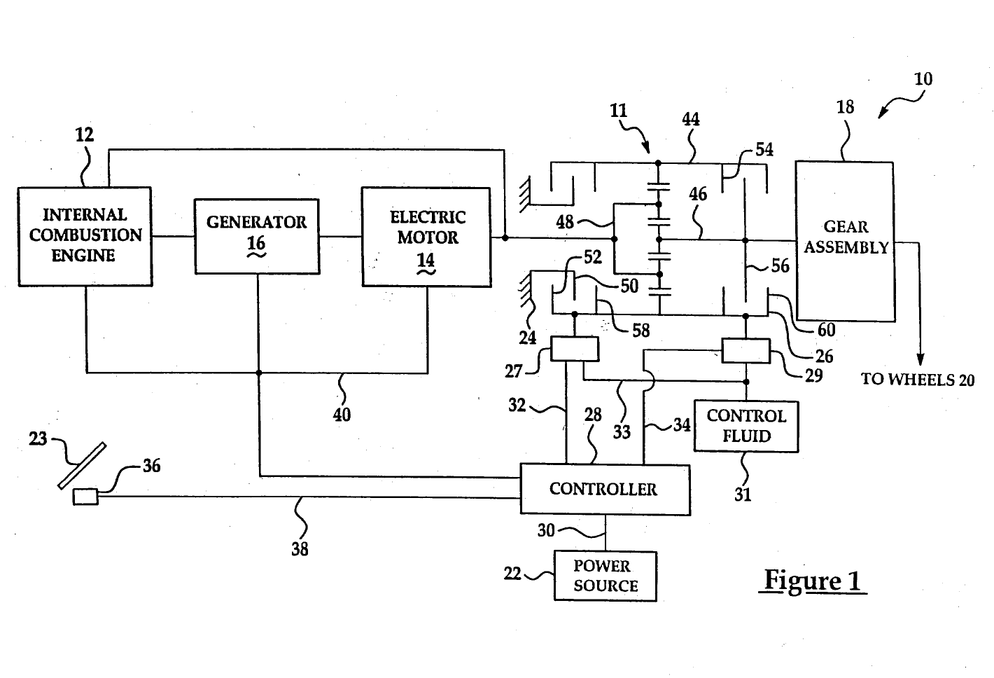

Referring now to FIG. 1, there is shown a hybrid vehicle 10 having a torque transfer assembly 11 which is made in accordance with the teachings of the preferred embodiment of the invention.

Particularly, assembly 11 comprises a transmission assembly and/or may be used as part of an overall transmission assembly and issued within a hybrid vehicle having an internal combustion engine 12, an electric motor 14, a generator 16, a differential or gear assembly 18, at least one wheel 20, a source of electrical power 22 (which may comprise a vehicular battery), and an accelerator pedal or member 23. It should be appreciated that the invention is applicable to and may be used within a wide variety of hybrid vehicles and is not limited to use within a hybrid electric vehicle.

As shown, assembly 11 includes a first clutch assembly 24, a second clutch assembly 26, actuators 27, 29, a controller 28 which is operable under stored program control, and a source of control fluid 31. Controller 28 is physically coupled to the source of electrical power 22, by bus 30, and to the actuators 27, 29 by respective busses 32 and 34. Actuators 27, 29 are respectively and communicatively coupled to the control fluid source 31, by conduit 33, and are respectively and communicatively coupled to clutch assemblies 24, 26. Assembly 10 further includes a position sensor 36 which senses the position of the accelerator pedal or member 23 and which is communicatively coupled to the controller 28 by bus 38. Moreover, controller 28 may be controllably coupled to the internal combustion engine 12, to the generator 16, and to the electric motor 14 by the use of bus 40.

In operation, the controller 28 selectively causes one or both of the internal combustion engine 12 and the electric motor 14 to be operated. More particularly, the electric motor 14 is operated upon receipt of electrical power from the generator 16. Internal combustion engine 12 is “activated” by causing a mixture of air and fuel to selectively enter the various cylinders (not shown) of the internal combustion engine 12 and to be respectively combusted in these cylinders. In one alternate embodiment, controller 28 is not connected to generator 16, internal combustion engine 12, and electric motor 14.

Rather, the previously delineated control is accomplished by another controller within the hybrid vehicle (not shown).

As shown, clutch assembly 24 is physically and operatively coupled to the clutch assembly 26 and these operatively coupled clutch assemblies 24, 26 include a ring gear or portion 44, a sun gear or portion 46, and a carrier gear or portion 48. The internal combustion engine 12 is physically and operatively coupled to the generator 16 and to the clutch 24, and the generator 16, is coupled to the electric motor 14. Further, the electic motor 14 and the internal combustion engine 12 are each coupled to the carrier 48.

In this non-limiting embodiment, only the electric motor 14 is used during launch. That is, launch is sensed by sensor 36 due to a change in the position of accelerator member 23. A signal is then generated and communicated to the controller 28, by the sensor 36, effective to cause the controller 28 to activate actuator 29 thereby causing actuator 29 to provide some of the fluid from source 31 to assembly 11, effective to disengage clutch 24 (e.g., plates 50 and 52 engage) and to engage clutch 26 (e.g., plates 54, 56 engage), thereby providing a relatively high gear ratio, allowing the torque energy to be communicated to the gear assembly 18 through the sun gear 46. In one non-limiting embodiment the “higher” gear ratio in about 6.0. After launch, the controller 28 activates actuator 27 and deactivates actuator 29 (e.g., actuator 27 provides fluid from source 31 to assembly 11 and actuator 29 is prevented from supplying such fluid), thereby causing the clutch 24 to be engaged (e.g., plates 50 and 58 engage) and the clutch 26 to be disengaged (e.g., plates 56 and 60 engage), thereby providing a relatively low gear ratio which is dependent upon the ratio of the sun gear 46 to the carrier gear 48. In one non-limiting embodiment the “low” gear or ratio is about 1.8. The torque emanating from the internal combustion engine 12 and/or from the electric motor 14 is communicated to the gear assembly 18 through the sun gear or portion 46. In the foregoing manner, the gear ratio provided by the assembly 11 is dynamically adjustable depending upon the operational mode of the vehicle. Further, sensor 36 may be replaced with a speed sensor which senses the speed of the vehicular engine (e.g., acceleration is sensed by use of the speed of the engine 12).

Further, in another non-limiting embodiment, when both actuators 27, 29 are deactivated (e.g., neither supply fluid to the assembly 11), plate 50 (e.g., by the use of a spring assembly), resides between plates 52, 58 and plate 56 resides between plates 54, 60, thereby desirably providing a neutral gear arrangement. In yet another non-limiting embodiment, the control fluid source 31 may be coupled to a pump (not shown) which may be selectively activated even when the internal combustion engine 12 is not operational. The pump may therefore selectively cause the contained fluid to be selectively communicated to the assembly 11 even when the engine 12 is not operational.

Further, in yet another non-limiting embodiment, plate 52 may be biased against plate 50, thereby allowing electric power to be communicated to the power source 22 from the generator 16. Hence, assembly 11 dynamically “regulates” the torque which is provided to the wheels 20 by dynamically allocating the amount of torque which is provided to the at least one wheel 20 depending upon the operational mode of the vehicle and by allowing a neutral gear arrangement to be selected without the use of a complicated spur gear arrangement.

It is to be understood that the invention is not limited to the exact construction which has been previously delineated above, but that various changes and modifications may be made without departing from the spirit and the scope of the inventions as are more fully delineated in the following claims.

What is claimed is:

1) An assembly which regulates the amount of torque provided from a motor to at least one wheel of a hybrid vehicle.

2) The assembly of claim 1 wherein said assembly regulates said amount of torque by providing a selected one of three gear arrangements including a neutral gear arrangement.

3) The assembly of claim 2 comprising a gear assembly; and a pair of clutches.

4) The assembly of claim 3 further comprising a controller which is coupled to said pair of clutches; and a sensor which is coupled to said controller and which selectively generates and communicates a signal to said controller, effective to cause said controller to cause said assembly to provide said selected one of said three gear ratios.

5) The assembly of claim 4 wherein said sensor comprises a position sensor.

6) The assembly of claim 4 wherein said sensor comprises a speed sensor.

7) The assembly of claim 4 wherein two of said three gear ratios respectively comprise a first ratio of about 6 and a second ratio of about 1.8.

8) The assembly of claim 1 being further adapted to selectively regulate the amount of torque provided by an engine to said at least one wheel.

9) The assembly of claim 8 wherein at least one of said pair of clutches is biased in a closed position, effective to allow electric power to be communicated to a power source.

10) A hybrid vehicle comprising at least two torque production sources; at least one wheel; and a transmission assembly which is adapted to receive a first amount of torque from at least one of said at least two torque production sources and to communicate second and third amounts of torque to said at least one wheel; and a controller which is coupled to said transmission assembly and which causes said second amount of torque to be communicated to said at least one wheel during launch and said third amount of torque to be communicated to said at least one wheel after launch, wherein said third amount of torque is less than said second amount of torque.

11) The transmission assembly of claim 10 comprising a gear assembly; and a pair of clutches.

12) The transmission assembly of claim 11 wherein said at least one source comprises an electric motor.

13) The transmission assembly of claim 11 wherein said at least one source comprises an internal combustion engine.

14) The transmission assembly of claim 11 further comprising a sensor which generates and communicates a signal to said controller, effective to cause said controller to cause said transmission assembly to provide one of two gear ratios.

15) The transmission assembly of claim 14 wherein said sensor comprises a speed sensor.

16) The transmission assembly of claim 14 wherein said sensor comprises a position sensor.

17) The transmission assembly of claim 14 wherein a first of said two gear ratios equals about 6 and wherein a second of said two gear ratios equals about 1.8.

18) A method for transmitting torque emanating from at least one of two torque production sources to at least one wheel, said method comprising the steps of providing an assembly having a selectable gear ratio; transmitting said torque to said assembly; and communicating at least a portion of said torque from said assembly to said at least one wheel.

19) The method of claim 18 further comprising the steps of sensing a desired speed; and modifying said gear ratio in response to said sensed desired speed.

20) The method of claim 19 further comprising the step of providing a neutral gear arrangement.
